(19) United States
(12) Patent Application Publication
(10) Pub. No.: US 2025/0112933 A1
(43) Pub. Date: Apr. 3, 2025

(54) SYSTEMS AND METHODS FOR HARDWARE MESSAGE PROCESSING

(71) Applicant: Xilinx, Inc., San Jose, CA (US)

(72) Inventors: David Andrews, Edinburgh (GB); David Lawrie, Edinburgh (GB); Victor Wu, San Jose, CA (US); Po-Ching Sun, San Jose, CA (US); Dmitri Kitariev, Irvine, CA (US); David Riddoch, Cambridge (GB)

(73) Assignee: Xilinx, Inc., San Jose, CA (US)

(21) Appl. No.: 18/478,438

(22) Filed: Sep. 29, 2023

(51) Int. Cl. H04L 9/40; H04L 1/00; H04L 43/0823

(52) U.S. Cl. CPC H04L 63/123; H04L 1/0061; H04L 43/0847

(57) ABSTRACT

Described herein are systems and methods for managing error detection in a message. A circuit can identify, based on an error detection configuration of the at least one circuit, a first portion of the message to be checked for errors before a second portion of the message is available to the at least one circuit, the first portion being less than all of the message to be checked for one or more errors. A circuit can analyze a number of bits of the first portion of the message using the at least one circuit and based on the error detection configuration. A circuit can, based on analyzing the first portion, determine whether the message includes the one or more errors. Various other methods, systems, and computer-readable media are also disclosed.

### BACKGROUND

Messages can be transmitted among different devices or among various hardware and software components with different capabilities and/or functionalities. Such messages may be transmitted over a network in some cases, such as a network-on-a-chip (NoC), a wired communication network, a wireless communication network, or other physical layer. A variety of network protocols may also be used.

### BRIEF DESCRIPTION OF THE DRAWINGS

The accompanying drawings illustrate a number of example implementations and are a part of the specification. Together with the following description, these drawings demonstrate and explain various principles of the present disclosure.

FIG. 1 is a block diagram of an example system for message-processing using hardware components.

FIG. 2 is a detailed block diagram of another example system for message-processing using hardware components.

FIG. 3 is a block diagram of a computer system with which some implementations can operate.

FIG. 4 is a flow diagram of an example method for error detection in a message.

FIG. 5 is a flow diagram of an example method for analyzing a message.

FIG. 6 is a flow diagram of an example method for error detection based on an error detection configuration.

FIG. 7 is a flow diagram of an example method for error detection based on an error detection configuration.

Throughout the drawings, identical reference characters and descriptions indicate similar, but not necessarily identical, elements. While the example implementations described herein are susceptible to various modifications and alternative forms, specific implementations have been shown by way of example in the drawings and will be described in detail herein. However, the example implementations described herein are not intended to be limited to the particular forms disclosed. Rather, the present disclosure covers all modifications, equivalents, and alternatives falling within the scope of the appended claims.

### DETAILED DESCRIPTION

Described herein are examples of systems and methods for processing messages using one or more hardware components. It can be advantageous in some cases to arrange hardware elements to perform processing of messages, as hardware elements may be able to perform message-processing at higher speed than possible with other implementations such as software. But the speed advantages of hardware can be offset by difficulties in configurability and reconfigurability of processing, which can hamper message-processing in situations in which different techniques might be desirable at different times.

Some techniques and systems described herein include use of hardware components to perform error detection for messages. In some cases, to increase throughput on error detection, one or more circuits may be arranged to perform error detection on a portion of a message. For examples, some implementations can include identifying a first portion (e.g., packet) of a message to be checked for errors before a second portion of the message is available. The identification can be based on an error detection configuration of the one or more circuits. The first portion of the message can be less than all of the message to be checked for one or more errors, with a number of bits (e.g., region), as selected by the error detection configuration, of the first portion of the message being analyzed by the circuit(s) based on the error detection configuration. Based on the analysis of the first portion, a determination can be made of whether the message includes one or more errors. In some cases, the circuit(s) can include a second error detection configuration for analyzing the message to detect errors that might not be detected based on the first error detection configuration. In other cases, the circuit(s) can include a second error detection configuration that is used for error detection for a second message different from the first message, and in some such cases analysis by the circuit(s) of portions of the first message can be interleaved with analysis of portions of the second message (e.g., a portion of a second message is analyzed after the first portion of the first message but before the second portion of the first message is made available). In some such implementations, the circuit(s) can be reconfigured between messages with the error detection configuration to be used for the message (e.g., the first error detection configuration for a first message and the second error detection configuration for a second message).

In some implementations, as each portion of the packets of the message is analyzed, the result of the analysis can also be stored (e.g., in memory) with an identifier of the message with which the analysis is associated. As additional portions of the message become available for analysis, the identifier can be used to retrieve the analysis of previous portions. In some implementations, a queue of such identifiers and associated analysis can be maintained in data store, such as a random-access memory or other storage. Subsequently, in some cases the analysis associated with each portion of the message can be combined, such that an analysis of the entire message can be produced. Implementations are not limited to any particular technique for combining results of error detection analyses for portions of messages to produce an error detection result for a message, or to any particular technique for analyzing a result of the combination. In some implementations, the analysis (e.g., value) for the entire message can be compared to a reference analysis (e.g., reference value) to determine whether the message includes one or more errors. For example, errors can be detected if the values are different. The analysis can be incorporated (e.g., edited) into the message as a reference value for subsequent error detection of the message.

A processing unit, such as a buffer subsystem or an integrated circuit able to execute instructions or other processing unit, can handle messages being transmitted among components. For example, as messages are transmitted between a host and a network, the buffer subsystem can be an intermediary circuit that receives, processes, and streams these messages. Such processing can include performing one or more operations on the messages such as identifying data of the messages, computing one or more values from the data, analyzing the one or more values for error detection, generating one or more outputs of the analysis, and conveying the messages to a particular destination (inside or outside the processing unit, or to an interface of the processing unit). In some cases, the processing unit receives commands for specifying or configuring how each of the messages and their data are to be analyzed and processed, such as in a case that a command indicates a particular operation to be performed on or with the data in the message. In some cases, the command can specify a number of bits to analyze, or a computation to perform for output and/or incorporation into the message for error detection.

In a case that messages (e.g., commands) are transmitted among multiple circuits and network locations, it can be the case that the data in the messages gets inadvertently modified. For example, a bit might get toggled during the transmission and/or processing of the message, which may change or otherwise corrupt the data in the message.

In some cases, a message can be transmitted as one or more packets, each of which contain some data of the message. This can include a case in which a message is received as a sequence of multiple packets. It can be helpful that all the packets of a message be analyzed together to detect errors in the message, for example, after all the packets are received and made available for analysis. However, if there is delay before all packets are made available or analyzed, circumstances can arise in which the detection of errors could also be delayed or be done incorrectly, or error detection for one message delays error detection for another message.

In processing units that handle multiple messages and in which their packets are made available in a non-contiguous manner, it can arise that different packets are made available at different times. However, conventional analysis techniques might not be able to analyze the message for errors until all the associated packets are made available. As a result, the analysis of a message that is missing a packet could end up being delayed until the remaining packets are made available, which may also delay the analysis of other messages that have to wait until analysis of the current message is completed.

As another example of difficulties that could arise, even if the message is analyzed for errors after all the packets are made available, that analysis can be computationally inefficient and inaccurate. For example, having to analyze the entire message would result in time wasted on analyzing every bit in each packet of the message, which can reduce overall efficiency of processing. Moreover, existing data verification techniques can fail to detect all the errors. For example, checksum processes are based on addition, which may fail to detect double errors that do not change the sum of the bits. In another example, cyclic redundancy check (CRC) processes are based on polynomial division, which may fail to detect errors that alter the data by the polynomial used in the division.

Attempts have previously been made at error detection in a message, but the inventors have recognized and appreciated that prior solutions necessitated large resource consumption that led to inefficiencies in design and operation for error detection in the message. For example, some prior solutions waited for the entire message to be made available by waiting for all the packets to be made available, analyzing the entire message only after it was fully available, and ensuring that the entire message was analyzed before analyzing a different message. The inventors recognized and appreciated limitations of this solution. For example, it was difficult to wait until the message was made available in its entirety, as its packets might be made available in a non-contiguous manner if they are made available out of order and at different times. In addition, as the number of packets of the message and the number of messages increases, the computation complexity increases because the size of data to be analyzed for errors in a time period often also increases. Analyzing the entire message from all the packets with this prior solution necessitated more idle time waiting for the message to be made available and more computational effort to analyze the entire message, meaning it was more difficult to determine whether the message included errors. This led to increasing complexity of systems for error detection in the message, without necessarily improving the efficacy of error detection.

Described herein are techniques that can aid in reducing resources used by processing units for error detection of a message. Some techniques described herein can be configured with error detection configurations that each define how the packets of the message are analyzed, such as which portion of the packets of the message to analyze, analysis techniques with which to analyze the packets, and the output of the analysis. Upon receipt of each packet, one or more circuits can perform the analysis on the particular portion of the packet of the message based on the error detection configuration. For example, the error detection configuration can configure the byte offset from which the circuit will start analyzing the packet, and the byte length that the circuit(s) will analyze from that start point. Once the packet is selected for analysis, the error detection configuration can define analysis techniques such as those associated with bitwise operations. As such, the error detection configurations can define handling error detection in a variety of ways, since each error detection configuration can define a unique approach. The circuit(s) can be subsequently configured with various error detection configurations, as discussed below, to perform a variety of operations for error detection in the messages.

In some implementations, the error detection configurations can specify a variety of analysis techniques for analyzing the portions of the packets of the messages. In some implementations, the circuit has a number (e.g., two) of separate computational paths for processing the messages, and it can be the case that each is associated with a particular type of error detection (e.g., CRC and checksum). The processing unit can select error detection configuration within each path to initialize the analysis of the message as packets of the message become available and/or depending on the attributes of each incoming message.

For analysis techniques based on CRC, the error detection configurations can specify the polynomial used for the CRC analysis. Examples of the polynomials include 16-bit, 32-bit, 64-bit, and 128-bit. In some implementations, based on the error detection configuration, the circuit can apply bitwise operations to the portions of the packets. For example, the circuit can reverse the bits of the portion before analysis, reverse the bits of the error detection value, or invert the bits of the error detection value.

For analysis techniques based on checksum, the error detection configurations can specify which type of checksum protocol (TCP/UDP) to utilize, whether to generate a 16-bit checksum or a status indicator, the size and offset of the portion for checksum processing, the offset of the checksum field in the portion, and/or any additional data to factor into the checksum calculation. In some implementations in which the specified portions of the packets of the messages are analyzed in a manner in accordance with the error detection configuration, the number of bits that need to be analyzed can be less than what was needed with prior solutions that analyzed the entire message, resulting in reduction of resources needed to analyze messages for error detection as compared to other techniques.

In some implementations, the circuit can be reconfigured with different error detection configurations during each clock cycle, such that each packet of each message can be analyzed by their corresponding error detection configuration. In a case in which there are multiple different messages being analyzed, different messages can correspond to different error detection configurations. In some implementations, all the packets of a message are analyzed based on the same error detection configuration, while in other implementations, different packets of the same message can be analyzed based on different error detection configurations. In an implementation in which packets of different messages are made available at interleaving times, the circuit can be reconfigured with the error detection configuration as each packet of each message is made available for analysis.

For example, the circuit can be configured with a first error detection configuration for a first packet of a first message, then the circuit can be configured with a second error detection configuration for packets of a second message, and then the circuit can be again configured with the first error detection configuration for a second packet of the first message. As discussed above, in some cases, techniques described herein can be used to reduce delays arising from waiting to analyze the message until all the packets are made available. This can aid in ensuring, in some such implementations, that packets for a different message are still analyzed while packets of other messages are not yet available. As such, when the packets of the message are separated from one another and made available at different times, the circuit can separately analyze the portions as they are made available. The analysis of each individual portion can be subsequently combined, as discussed below, to generate an aggregate analysis of the message.

Subsequently, after a portion of a message is analyzed, an error detection value relating to error detection for the portion (and/or one or more other portions of the message, such as a previously processed portion) can be stored while awaiting subsequent packets to be made available. For example, the error detection value can be stored in a data store, such as a register, a random-access memory (RAM), or other storage. In addition to storing the error detection value in the storage, the circuit can assign an identifier to the error detection value, which indicates the message with which the error detection value is associated. As subsequent packets are analyzed, the identifier can be used to retrieve the error detection value, which can be combined with additional error detection value to prepare a cumulative analysis of the entire message. Different identifiers of different messages can be selected during each clock cycle. In some such implementations, the error detection value can be forwarded along for combination with other error detection value.

For example, in a case that error detection is to be performed using cyclic redundancy check (CRC) and a portion of a message is analyzed for errors, a CRC result for a portion of a message (e.g., a most recent partial CRC result for one or more portions of a message) can be obtained by the circuit to be combined with previously calculated partial CRC results. To combine portions having different bit-lengths, the circuit can pre-pad the analyzed portions with zeroes to shift the portions until their bit-length of the portions align with a boundary. For example, the circuit can perform pre-padding so that the processing of the portions ends on a 1024-bit aligned boundary. By performing the appropriate shifting with the pre-padding of zeros, the circuit can extract any sized region from the packet of the message and then add zeros to extend the extraction to an appropriate bit-length. The circuit can then incrementally process and combine multiple extractions (e.g., CRC results) into an aggregate analysis.

In some implementations, the circuit can perform modification operations on the packets after the analysis described above. For example, the circuit can copy or compare 1, 2, 4, 8, or 16 bytes of data associated with the error detection value. In some implementations, the packets can include a previously generated error detection value (e.g., CRC or checksum value, or other error detection technique). In some implementations, the circuit can copy the error detection value into the packets. For example, the circuit can modify the packet to include the error detection value (e.g., computed CRC or checksum). As the packet is transmitted to other circuits (e.g., inline circuits), the error detection value in the packet can be used by those other circuits as a reference against which to compare error detection value that they generate. The other circuits can generate error detection value based on the portion of the packet that they receive, and the modification operation can compare the generated error detection value to the previously generated error detection value that is already in the packet. Based on the comparison, the circuit can detect whether the packet associated with the error detection value has errors. If the comparison indicates that the error detection value and the previously generated result in the packet are the same, then the packet does not have any errors. Conversely, if the comparison indicates that the error detection value and the previously generated result in the packet are different, then it may be determined that the packet includes errors and/or the packet may be flagged as potentially including errors.

As will be described in greater detail below, the present disclosure describes various systems and methods for hardware message processing.

In some implementations, the techniques described herein relate to a method for error detection in a message, the method being performed with at least one circuit, the method including: identifying, based on an error detection configuration of the at least one circuit, a first portion of the message to be checked for errors before a second portion of the message is available to the at least one circuit, the first portion being less than all of the message to be checked for one or more errors; analyzing a number of bits of the first portion of the message using the at least one circuit and based on the error detection configuration; and based on analyzing the first portion, determining whether the message includes the one or more errors.

In some implementations, the techniques described herein relate to a method, further including: configuring the at least one circuit with the error detection configuration from a plurality of error detection configurations, prior to identifying the first portion of the message to be checked for the one or more errors.

In some implementations, the techniques described herein relate to a method, further including: receiving, based on the error detection configuration of the at least one circuit, the second portion of the message to be checked for the one or more errors, the second portion being less than all of the message to be checked for the one or more errors; analyzing the number of bits of the second portion of the message using the at least one circuit and based on the error detection configuration; and determining, based on analyzing of the first portion and the second portion, whether the message includes the one or more errors.

In some implementations, the techniques described herein relate to a method, further including: retrieving, from memory, a first error detection value associated with analyzing the first portion of the message; generating an aggregate error detection value of the message from the first error detection value and a second error detection value associated with analyzing the second portion of the message; and determining, based on the aggregate error detection value, whether the message includes the one or more errors.

In some implementations, the techniques described herein relate to a method, further including: identifying, using the at least one circuit, an initial error detection value that was generated and edited into the message; and determining whether the message includes the one or more errors by comparing the aggregate error detection value to the initial error detection value in the message.

In some implementations, the techniques described herein relate to a method, further including: modifying the message to include the aggregate error detection value.

In some implementations, the techniques described herein relate to a method, wherein: the error detection configuration is a first error detection configuration; the number of bits is a first number of bits; and the method further includes: configuring the at least one circuit with a second error detection configuration of a plurality of error detection configurations, the plurality of error detection configurations including the first error detection configuration and the second error detection configuration being different from the first error detection configuration; identifying, based on the second error detection configuration of the at least one circuit, a third portion and a fourth portion of the message to be checked for the one or more errors, the third portion and the fourth portion being less than all of the message to be checked for the one or more errors; analyzing a second number of bits of the third portion and the fourth portion of the message using the at least one circuit and based on the second error detection configuration; and based on analyzing the third portion and the fourth portion, determining whether the message includes the one or more errors.

In some implementations, the techniques described herein relate to a method, further including: analyzing, using the at least one circuit and based on the first error detection configuration, the first portion and the second portion of the message by generating a first polynomial division of bits in the first portion and a second polynomial division of the second portion of the message; analyzing, using the at least one circuit and based on the second error detection configuration, the third portion and the fourth portion of the message by generating a first addition of bits in the third portion and a second addition of the fourth portion of the message; and determining whether the message includes the one or more errors based on analyzing the first portion, the second portion, the third portion, and the fourth portion.

In some implementations, the techniques described herein relate to a method, wherein: the error detection configuration is a first error detection configuration; the message is a first message; the number of bits is a first number of bits; and the method further includes: configuring the at least one circuit with a second error detection configuration of a plurality of error detection configurations, the plurality of error detection configurations including the first error detection configuration and the second error detection configuration being different from the first error detection configuration; identifying, based on the second error detection configuration of the at least one circuit, a third portion of a second message to be checked for the one or more errors, the third portion being less than all of the second message to be checked for the one or more errors; analyzing a second number of bits of the third portion of the second message using the at least one circuit and based on the second error detection configuration; and based on analyzing the third portion, determining whether the second message includes the one or more errors.

In some implementations, the techniques described herein relate to a method, wherein: the at least one circuit receives the third portion of the second message between the first portion of the first message and the second portion of the first message; configuring of the at least one circuit with the second error detection configuration is performed after analyzing the first portion of the message using the at least one circuit and based on the first error detection configuration; and the method further includes: configuring the at least one circuit with the first error detection configuration after analyzing the third portion of the second message using the at least one circuit and based on the second error detection configuration.

In some implementations, the techniques described herein relate to a system for error detection in a message, the system including: a computation circuit configured to: identify, based on an error detection configuration of the computation circuit, a first portion of the message to be checked for one or more errors before a second portion of the message is available to the computation circuit, the first portion being less than all of the message to be checked for the one or more errors; and analyze a number of bits of the first portion of the message based on the error detection configuration; and a modification circuit configured to, based on analyzing the first portion, determine whether the message includes the one or more errors.

In some implementations, the techniques described herein relate to a system, wherein the computation circuit is further configured with the error detection configuration from a plurality of error detection configurations, prior to identifying the first portion of the message to be checked for the one or more errors.

In some implementations, the techniques described herein relate to a system, wherein: the computation circuit is further configured to: receive, based on the error detection configuration of the computation circuit, the second portion of the message to be checked for the one or more errors, the second portion being less than all of the message to be checked for the one or more errors; and analyze the number of bits of the second portion of the message based on the error detection configuration; and the modification circuit is further configured to: determine, based on analyzing of the first portion and the second portion, whether the message includes the one or more errors.

In some implementations, the techniques described herein relate to a system, wherein: the computation circuit is further configured to: retrieve, from memory, a first error detection value associated with analyzing the first portion of the message; and generate an aggregate error detection value of the message from the first error detection value and a second error detection value associated with analyzing the second portion of the message; and the modification circuit is further configured to: determine, based on the aggregate error detection value, whether the message includes the one or more errors.

In some implementations, the techniques described herein relate to a system, wherein the modification circuit is further configured to: identify an initial error detection value that was generated and edited into the message; and determine whether the message includes the one or more errors by comparing the aggregate error detection value to the initial error detection value in the message.

In some implementations, the techniques described herein relate to a system, wherein the modification circuit is further configured to: modify the message to include the aggregate error detection value.

In some implementations, the techniques described herein relate to a system, wherein: the error detection configuration is a first error detection configuration; the number of bits is a first number of bits; the computation circuit is further configured with a second error detection configuration of a plurality of error detection configurations, the plurality of error detection configurations including the first error detection configuration and the second error detection configuration being different from the first error detection configuration; the computation circuit is further configured to: identify, based on the second error detection configuration of the computation circuit, a third portion and a fourth portion of the message to be checked for the one or more errors, the third portion being less than all of the message to be checked for the one or more errors; and analyze a second number of bits of the third portion and the fourth portion of the message based on the second error detection configuration; and the modification circuit is further configured to, based on analyzing the third portion and the fourth portion, determine whether the message includes the one or more errors.

In some implementations, the techniques described herein relate to a system, wherein: the computation circuit further includes a division circuit and an addition circuit; the division circuit is configured to analyze, based on the first error detection configuration, the first portion and the second portion of the message by generating a first polynomial division of bits in the first portion and a second polynomial division of the second portion of the message; the addition circuit is configured to analyze, based on the second error detection configuration, the third portion and the fourth portion of the message by generating a first addition of bits in the third portion and a second addition of the fourth portion of the message; and the modification circuit is further configured to determine whether the message includes the one or more errors based on analyzing the first portion, the second portion, the third portion, and the fourth portion.

In some implementations, the techniques described herein relate to a system, wherein: the error detection configuration is a first error detection configuration; the message is a first message; the number of bits is a first number of bits; the computation circuit is further configured with a second error detection configuration of a plurality of error detection configurations, the plurality of error detection configurations including the first error detection configuration and the second error detection configuration being different from the first error detection configuration; the computation circuit is further configured to: identify, based on the second error detection configuration of the computation circuit, a third portion of a second message to be checked for the one or more errors, the third portion being less than all of the second message to be checked for the one or more errors; and analyze a second number of bits of the third portion of the second message based on the second error detection configuration; and the modification circuit is further configured to, based on analyzing the third portion, determining whether the second message includes the one or more errors.

In some implementations, the techniques described herein relate to a system, wherein: the computation circuit receives the third portion of the second message between the first portion of the first message and the second portion of the first message; configuring of the computation circuit with the second error detection configuration is performed after analyzing the first portion of the message based on the first error detection configuration; and the computation circuit is further configured with the first error detection configuration after analyzing the third portion of the second message based on the second error detection configuration.

Features from any of the implementations described herein can be used in combination with one another in accordance with the general principles described herein. These and other implementations, features, and advantages will be more fully understood upon reading the following detailed description in conjunction with the accompanying drawings and claims.

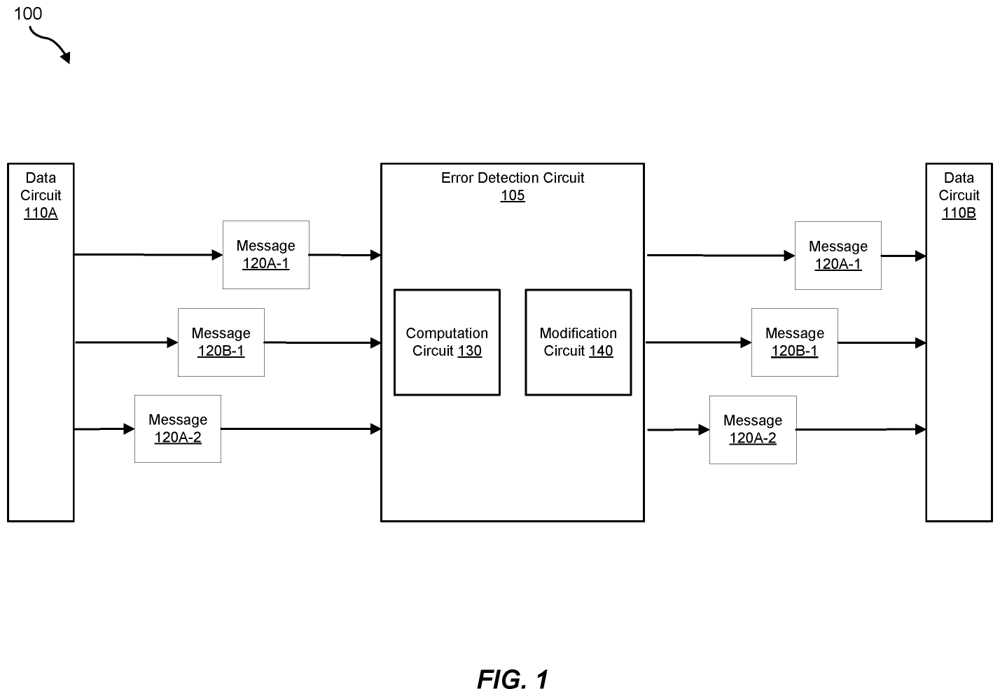

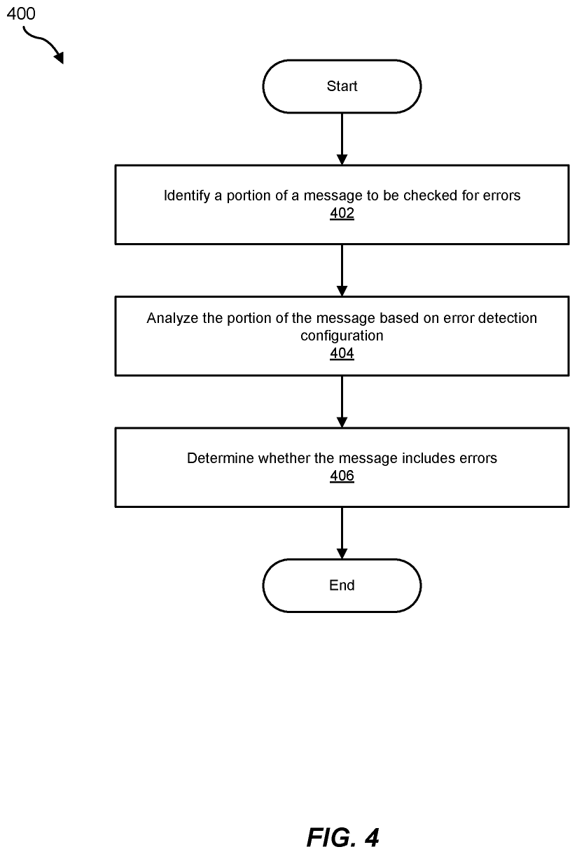

Below are provided, with reference to FIGS. 1-3, detailed descriptions of example systems for hardware message processing. Detailed descriptions of examples of computer-implemented methods are also provided in connection with FIGS. 4-7. It should be appreciated that while example implementations are provided, other implementations are possible, and implementations are not limited to operating in accordance with the examples below.

FIG. 1 is a block diagram of an example system 100 for error detection in a message. As illustrated in this figure, example system 100 can include an error detection circuit 105 for determining whether messages transmitted between a data circuit 110A and a data circuit 110B included errors. The error detection circuit 105 can include a computation circuit 130 and a modification circuit 140 for error detection in the messages.

In some implementations, the system 100 of FIG. 1 can be included within a chip, such as an integrated circuit, system on a chip (SoC), or other chip. In some cases, the chip can be a processing unit, such as a data processing unit (DPU), central processing unit (CPU), or graphics processing unit (GPU). Example system 100 can include the one or more controllers for performing one or more tasks, such as in response to instructions to be executed by the one or more controllers.

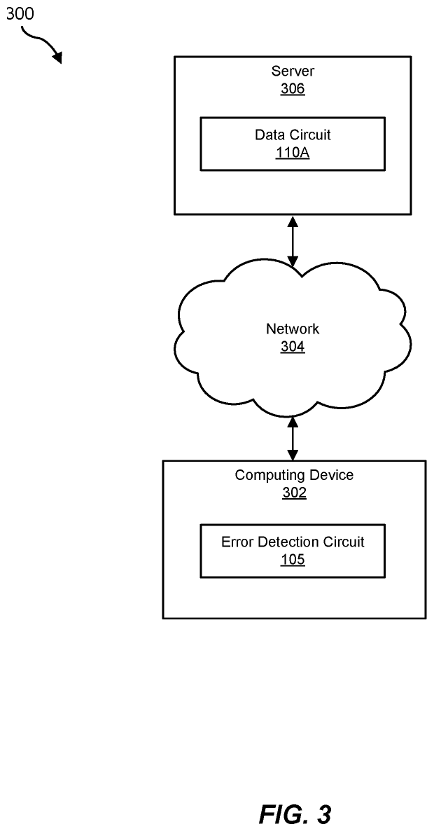

In certain implementations, the system 100 can be a component of one or more computing devices, such as the devices illustrated in FIG. 3 (e.g., computing device 302 and/or server 306). For example, the computing device 302 can include the system 100 and/or the server 306 can include the system 100. The system 300 in FIG. 3 can represent all or portions of one or more special-purpose computers configured to perform one or more tasks.

While not explicitly illustrated in FIG. 1, example system 100 can also include one or more memory devices. Memory generally represents any type or form of volatile or non-volatile storage device or medium capable of storing data and/or computer-readable instructions. In one example, memory can store, load, and/or maintain the one or more controllers. Examples of memory include, without limitation, Random Access Memory (RAM), Read Only Memory (ROM), flash memory, caches, variations or combinations of one or more of the same, or any other suitable storage memory.

As illustrated in FIG. 1, the error detection circuit 105 can be or include one or more circuits, such as computation circuit 130 and the modification circuit 140. While each illustrated as a single circuit, those skilled in the art will appreciate that the computation circuit 130 and the modification circuit 140 may each be implemented as one or more circuits. In addition, as will be discussed in further detail below, some implementations may include a sequence of the computation circuit 130 and the modification circuit 140 that includes the computation circuit 130 interleaved with the modification circuit 140. In some such cases, the computation circuit 130 and the modification circuit 140 can be configured differently from one another. For example, if the computation circuit 130 is included, the computation circuit 130 can be configured with different error detection configuration, such that some are using CRC error detection and some are using checksum error detection, or other configurations. In some cases that include such a sequence of circuits, a value calculated by the computation circuit 130 in the pipeline can be used to edit a message by the modification circuit 140, such as by adding the value to the message by the modification circuit 140 or performing another edit.

Circuits can represent any type or form of hardware-implemented processing unit capable of interpreting and/or executing computer-readable instructions. In one example, the one or more circuits can access and/or modify one or more bits of the one or more portions of the one or more messages (e.g., message 120A-1, message 120B-1, and/or message 120A-2) of the system 100. In one example, the one or more circuits can access and/or modify the memory of the system 100. Additionally, or alternatively, the one or more circuits can process one or more of components of the system 100 to facilitate error detection of the messages. Examples of the one or more circuits include, without limitation, cores, logic units, microprocessors, microcontrollers, Field-Programmable Gate Arrays (FPGAs) that implement softcore processors, Application-Specific Integrated Circuits (ASICs), portions of one or more of the same, variations or combinations of one or more of the same, or any other suitable physical processor.

The error detection circuit 105 can be intermediary to data circuits (e.g., data circuit 110A and data circuit 110B), which can facilitate the transmissions of the messages among various circuits. Examples of the data circuits include, without limitation, cores, logic units, microprocessors, microcontrollers, Field-Programmable Gate Arrays (FPGAs) that implement softcore processors, Application-Specific Integrated Circuits (ASICs), portions of one or more of the same, variations or combinations of one or more of the same, or any other suitable physical processor.

Messages (e.g., message 120A-1, message 120B-1, and/or message 120A-2) can include any number of commands, packets, or computer-readable instructions. Examples of the content included in the messages include network data, payloads, addresses, definitions, headers, protocols, identifiers, checksum values, CRC values, hashes or any other instructions received from a Network on Chip (NoC), Network Interface Controller (NIC), user logic, or fabric adapter. The messages can be configured to be transmitted among devices, data circuits, or other entities.

A message can include one or more portions. For example, the portions can be packets, such that each packet is transmitted separately between the data circuits to transmit the entire message. In some implementations, the message 120A-1 can be a first portion of the message and the message 120A-2 can be a second portion of the same message. In some implementations, the message 120B-1 can be a portion of a different message that is transmitted between the first portion of the message 120A-1 and the second portion of the message 120A-2.

In some implementations, the computation circuit 130 can receive the messages from the data circuits (e.g., data circuit 110A). The computation circuit 130 can be configured with one or more error detection configurations that define how to analyze the messages. The computation circuit 130 can extract and/or analyze a portion of the messages based on the error detection configurations. In some implementations, the error detection configurations can specify a variety of analysis techniques for analyzing the portions of messages, such as packets of a message or other portions of a message. The computation circuit 130 can select error detection configuration to initialize the analysis of the message as packets of the message become available and/or depending on the attributes of each incoming message.

In some implementations, the computation circuit 130 can analyze a particular number of bits of the messages. For example, 16-bit, 32-bit, 64-bit, and 128-bits. The computation circuit 130 can generate an error detection value from the analysis of the messages. The computation circuit 130 can output the error detection value to the modification circuit 140. In some cases, the computation circuit 130 can output the messages to the modification circuit 140, though implementations are not required to have messages output to the modification circuit 140 by the computation circuit 130, and implementations in which of the message are output to the modification circuit 140 are not limited to having all the messages output to the modification circuit 140 by the computation circuit 130. The computation circuit 130 can include software applications, firmware, or programs that, when executed by a circuit, integrated circuit, computing device, CPU, GPU, or DPU, can perform one or more tasks. The computation circuit 130 can analyze the messages. The computation circuit 130 can include any form of buffer, memory banks, first-in-first-out (FIFO) queues, memory Random Access Memory (RAM), cache, or any other type of memory described herein.

In some implementations, the modification circuit 140 can access and/or modify the messages or error detection value thereof. In some implementations, the modification circuit 140 can receive the messages from data circuits (e.g., data circuit 110A and data circuit 110B). In some implementations, the modification circuit 140 can receive the error detection value of the messages from the computation circuit 130 or from other computation circuits. In some implementations, the modification circuit 140 can receive the error detection value from the computation circuit 130 or from other circuits (e.g., a different error detection circuit).

In some implementations, the modification circuit 140 can copy, paste, and compare data among the messages and the error detection value. For example, the modification circuit 140 can copy the error detection value from one message to another message, copy the error detection value from the message to another circuit (e.g., copy the error detection value from the computation circuit 130 to the message), and/or copy the error detection value from another error detection circuit to the message.

In some implementations, the modification circuit 140 can compare the error detection value between the computation circuit 130 and the message. Comparing to the message can include comparing to a previous error detection value in the message, such as one computed when the message was originally generated and/or transmitted, prior to receipt at the error detection circuit 105. In some implementations, the modification circuit 140 can compare the error detection value between another error detection circuit and the message. In some implementations, the modification circuit 140 can store the comparison. For example, the modification circuit 140 can store the comparison in a storage or buffer. In some implementations, the modification circuit 140 can transmit the comparison. For example, the modification circuit 140 can transmit the comparison to other circuits via a status bus or a sideband output channel.

The modification circuit 140 can include software applications, firmware, or programs that, when executed by a circuit, integrated circuit, computing device, CPU, GPU, or DPU, can perform one or more tasks. The modification circuit 140 can analyze the messages. The modification circuit 140 can include any form of buffer, register, memory banks, first-in-first-out (FIFO) queues, memory Random Access Memory (RAM), cache, or any other type of memory described herein.

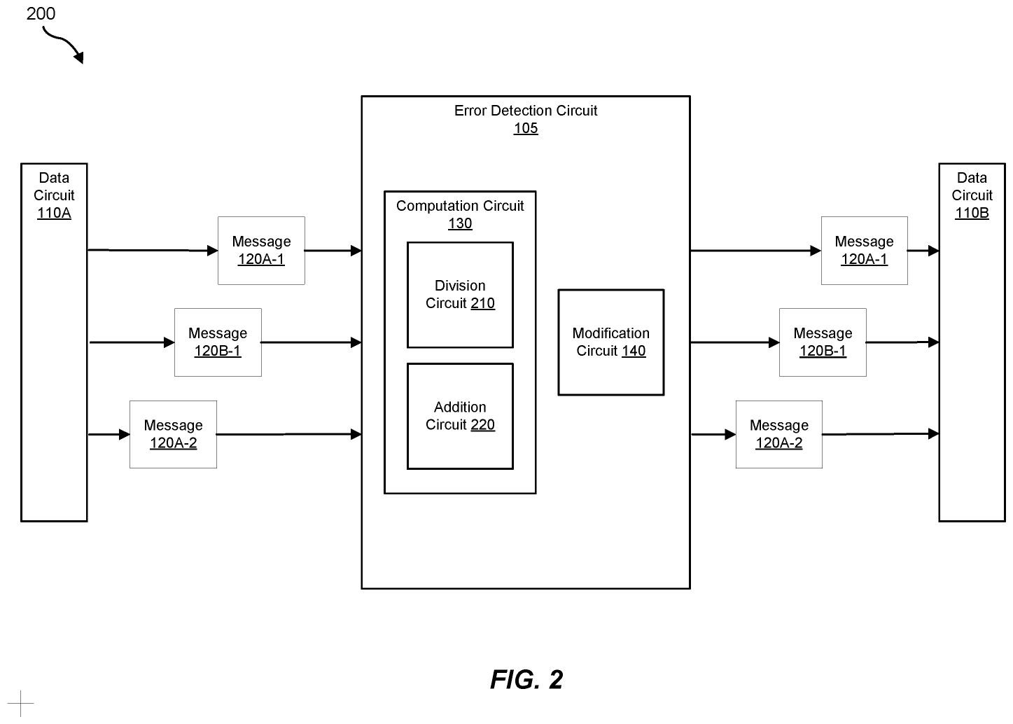

FIG. 2 illustrates another example system 200 with which some implementations can operate. Similar elements are labeled with corresponding numbers and labels from FIG. 1. Some functionality of elements shown in FIG. 2 is also described below in connection with FIGS. 4-7.

FIG. 2 illustrates the modification circuit 140 comprising a division circuit 210 and an addition circuit 220. In some implementations, the modification circuit 140 has a number (e.g., two) of separate computational paths for processing the messages, and it can be the case that each is associated with a particular type of error detection (e.g., CRC and checksum). However, implementations are not limited to operating with any particular number of computational pathways and not limited to making the computations to analyze the messages in any particular manner.

The division circuit 210 can generate the error detection value of the messages based on division techniques. For example, the division circuit 210 can apply CRC techniques. Any suitable CRC technique can be used, as implementations that use CRC are not limited in this respect. In some implementations, the error detection configurations for the division circuit 210 can specify the polynomial used for the CRC analysis. Examples of the polynomials include 16-bit, 32-bit, 64-bit, and 128-bit. In some implementations, based on the error detection configuration, the circuit can apply bitwise operations to the portions of the packets. For example, the division circuit 210 can reverse the bits of the portion before analysis, reverse the bits of the error detection value, and/or invert the bits of the error detection value.

The addition circuit 220 can generate the error detection value of the messages based on addition techniques. For example, the addition circuit 220 can apply checksum techniques. Any suitable checksum technique can be used, as implementations that use checksum are not limited in this respect. In some implementations, the error detection configurations for the addition circuit 220 can specify which type of checksum protocol (e.g., TCP/UDP) to utilize, whether to generate a 16-bit checksum or a status indicator, the size and offset of the portion for checksum processing, the offset of the checksum field in the portion, and/or any additional data to factor into the checksum calculation. In some implementations in which the specified portions of the packets of the messages are analyzed in a manner in accordance with the error detection configuration, efficiency of the analysis can be increased, such as in a case that less than all of the bits of the message are analyzed rather than all the bits of the message. For example, only 16-bit, 32-bit, 64-bit, and 128-bits of the message are analyzed instead of all the bits. Increased efficiency could arise from reduction of resources that may be needed for the analysis, such as smaller storage needed to store a fewer number of bits in some implementations. Increased efficiency could also arise in some implementations from lower times needed for transmitting, receiving, or processing a smaller number of bits as compared to a larger number of bits.

Example system 100 in FIG. 1 and system 200 in FIG. 2 can be implemented in a variety of systems. For example, all or a portion of system 100 and/or system 200 can represent portions of system 300 in FIG. 3. As shown in FIG. 3, system 300 can include a computing device 302 in communication with a server 306 via a network 304. In one example, all or a portion of the functionality of system 100 can be performed by the computing device 302, server 306, and/or any other suitable computing system. As will be described in greater detail below, one or more components from FIG. 1 can, when executed by at least one processor of computing device 302 and/or server 306, enable computing device 302 and/or server 306 to manage error detection in a message.

Computing device 302 generally represents any type or form of computing device capable of reading computer-executable instructions. For example, the computing device 302 can be an integrated circuit or a network interface controller (NIC). Additional examples of computing device 302 include, without limitation, laptops, tablets, desktops, servers, cellular phones, Personal Digital Assistants (PDAs), multimedia players, embedded systems, wearable devices (e.g., smart watches, smart glasses, etc.), smart vehicles, so-called Internet-of-Things devices (e.g., smart appliances, etc.), gaming consoles, variations or combinations of one or more of the same, or any other suitable computing device.

Server 306 generally represents any type or form of computing device that is capable of reading computer-executable instructions. For example, the server 306 can include circuits or network interfaces. Additional examples of server 306 include, without limitation, storage servers, database servers, application servers, and/or web servers configured to run certain software applications and/or provide various storage, database, and/or web services. Although illustrated as a single entity in FIG. 3, server 306 can include and/or represent a plurality of servers that work and/or operate in conjunction with one another.

Network 304 generally represents any medium or architecture capable of facilitating communication or data transfer. In one example, network 304 can facilitate communication between computing device 302 and server 306. In this example, network 304 can facilitate communication or data transfer using wireless and/or wired connections. Examples of network 304 include, without limitation, an intranet, a Wide Area Network (WAN), a Local Area Network (LAN), a Personal Area Network (PAN), the Internet, Power Line Communications (PLC), a cellular network (e.g., a Global System for Mobile Communications (GSM) network), portions of one or more of the same, variations or combinations of one or more of the same, or any other suitable network.

Many other devices or subsystems can be connected to system 100 in FIG. 1, system 200 in FIG. 2, and/or system 300 in FIG. 3. Conversely, all of the components and devices illustrated in FIGS. 1-3 need not be present to practice the implementations described and/or illustrated herein. The devices and subsystems referenced above can also be interconnected in different ways from that shown in FIG. 1-3. System 100, system 200, and system 300 can also employ any number of software, firmware, and/or hardware configurations. For example, one or more of the example implementations disclosed herein can be encoded as a computer program (also referred to as computer software, software applications, computer-readable instructions, and/or computer control logic) on a computer-readable medium.

The term “computer-readable medium,” as used herein, generally refers to any form of device, carrier, non-transitory medium, non-transitory computer-readable, or medium capable of storing or carrying computer-readable instructions. Examples of computer-readable media or non-transitory computer-readable include, without limitation, transmission-type media, such as carrier waves, and non-transitory type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other non-transitory or distribution systems.

FIG. 4 is a flow diagram of an example computer-implemented method 400 for error detection in a message. The steps shown in FIG. 4 can be performed by any suitable computer-executable code and/or computing system, including system 100 in FIG. 1, system 200 in FIG. 2, system 300 in FIG. 3, and/or variations or combinations of one or more of the same. In one example, each of the steps shown in FIG. 4 can represent an algorithm whose structure includes and/or is represented by multiple sub-steps, examples of which will be provided in greater detail below.

As illustrated in FIG. 4, at step 402, one or more of the systems described herein can identify a portion of a message to be checked for errors. For example, as part of step 402, the computation circuit 130 can, as part of system 100 in FIG. 1, receive messages, such as message 120A-1 from the data circuit 110A or another source. The systems described herein can perform step 402 in a variety of ways. In one example, the computation circuit 130 can manage the messages received from the data circuit 110A. In some implementations, the computation circuit 130 can store the messages in a buffer. For example, the computation circuit 130 can include a storage buffer where the messages are stored.

As illustrated in FIG. 4, at step 404, one or more of the systems described herein can analyze the portion of the message based on an error detection configuration. For example, the computation circuit 130 can, as part of system 100 in FIG. 1, analyze the portion of the message based on the error detection configuration. The systems described herein can perform step 404 in a variety of ways. In one example, the computation circuit 130 can be configured with one or more error detection configurations that define how to analyze the messages. For example, the error detection configurations can define which portion of the message to analyze, analysis techniques with which to analyze the packets, and/or the output of the analysis. Upon receipt of each packet, the computation circuit 130 can perform the analysis on the particular portion of the message based on the error detection configuration.

The computation circuit 130 can select error detection configuration to initialize the analysis of the message as packets of the message become available and/or depending on the attributes of each incoming message. In some implementations, the computation circuit 130 is configured with the error detection configuration from a plurality of error detection configurations. In some implementations, the error detection configurations can specify a variety of analysis techniques for analyzing the portions of the messages. The computation circuit 130 can be configured prior to identifying the message 120A-1 to be checked for the one or more errors. In some implementations, the computation circuit 130 can be configured based on the message itself after identifying the message to be checked for the one or more errors. For example, certain messages can be analyzed with certain error detection configurations. In another example, the message 120A-1 can be analyzed with a first error detection configuration, and then the computation circuit 130 can be reconfigured to be analyzed with a second error detection configuration to analyze the message 120A-2.

The computation circuit 130 can extract and/or analyze a portion of the messages based on the error detection configurations. In some implementations, the error detection configuration can define analysis techniques such as those associated with bitwise operations. For example, the error detection configuration can configure the byte offset from which the circuit will start analyzing the message, and the byte length that the circuit will analyze from that start point. In some implementations, the computation circuit 130 can analyze a number of bits of the message 120A-1. The number of bits can be selected based on the error detection configuration. The number of bits of the message 120A-1 can be less than the total number of bits in the message 120A-1. For example, only 16-bit, 32-bit, 64-bit, and 128-bits of the message are analyzed instead of all the bits. By not analyzing all the bits, resource utilization of the computation circuit 130 for error detection of the message can be reduced.

As illustrated in FIG. 4, at step 406, one or more of the systems described herein can determine whether the message includes errors. For example, the modification circuit 140 can, as part of system 100 in FIG. 1, determine whether the message includes errors based on the analysis performed by the computation circuit 130. The systems described herein can perform step 406 in a variety of ways. For example, the modification circuit 140 can compare the analysis performed by the computation circuit 130 to an expected analysis. The expected analysis can be identified in the packet or from a different computational circuit. It can be the case that the data in the messages gets inadvertently modified. For example, a bit might get toggled during the transmission and/or processing of the message, which may change or otherwise corrupt the data in the message. If the comparison indicates that the error detection value and the previously generated result in the packet are the same, then the packet does not have any errors. Conversely, if the comparison indicates that the error detection value and the previously generated result in the packet are different, then the packet includes errors.

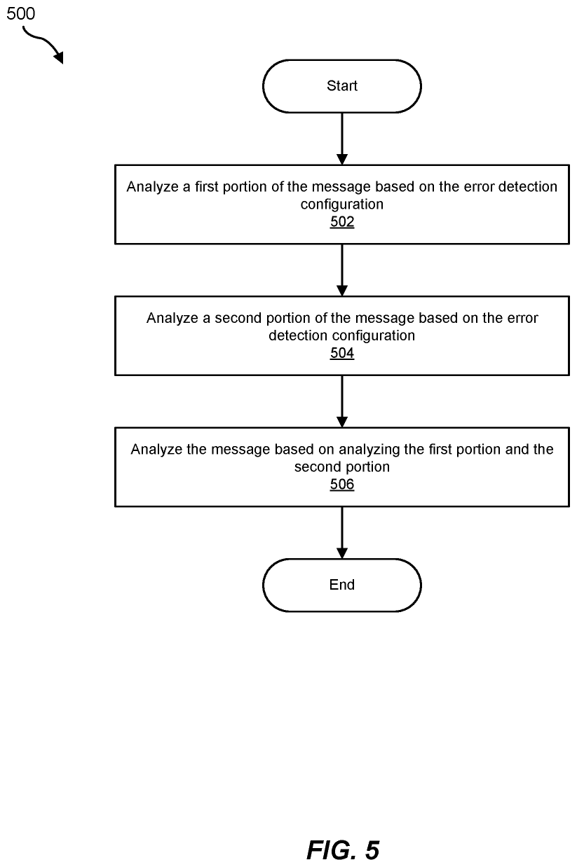

FIG. 5 is a flow diagram of an example computer-implemented method 500 for error detection in a message. The steps shown in FIG. 5 can be performed by any suitable computer-executable code and/or computing system, including system 100 in FIG. 1, system 200 in FIG. 2, system 300 in FIG. 3, and/or variations or combinations of one or more of the same. In one example, each of the steps shown in FIG. 5 can represent an algorithm whose structure includes and/or is represented by multiple sub-steps, examples of which will be provided in greater detail below.

As illustrated in FIG. 5, at step 502, one or more of the systems described herein can analyze the message 120A-1 based on the error detection configuration. For example, the computation circuit 130 can, as part of system 100 in FIG. 1, analyze the message 120A-1 based on the error detection configuration. The systems described herein can perform step 502 in a variety of ways. In one example, the computation circuit 130 can analyze the number of bits of the message 120A-1 based on the error detection configuration. In some implementations, the computation circuit 130 can generate an error detection value based on the analysis. For example, the computation circuit 130 can identify the messages in the order that they are made available. In some implementations, the computation circuit 130 can identify the message 120A-1. In some implementations, the message 120A-1 is less than the entire message to be checked for errors. For example, the message 120A-1 can be a first packet of many packets of a first message that is received at a first time.

In some implementations, after the message 120A-1 is analyzed, the error detection value can be stored while awaiting subsequent packets to be made available. For example, the error detection value can be stored in storage, such as a register, random access memory (RAM), or other storage. In addition to storing the error detection value in the storage, the computation circuit 130 can assign an identifier to the error detection value, which indicates the message with which the error detection value is associated. As subsequent packets are analyzed, the identifier can be used to retrieve the error detection value, which can be combined with additional error detection value to prepare a cumulative analysis of the entire message. Different identifiers of different messages can be selected during each clock cycle. In some implementations, the error detection value can be forwarded along for combination with other error detection value.

As illustrated in FIG. 5, at step 504, one or more of the systems described herein can analyze the message 120A-2 based on the error detection configuration. For example, the computation circuit 130 can, as part of system 100 in FIG. 1, analyze the message 120A-2 based on the error detection configuration. The systems described herein can perform step 504 in a variety of ways. In one example, the computation circuit 130 receive the message 120A-2 to be checked for the one or more errors. In some implementations, the computation circuit 130 can generate an error detection value associated with analyzing the message 120A-2.

The message 120A-2 can be less than all of the message to be checked for the one or more errors. In some implementations, the computation circuit 130 can identify the message 120A-1 of the message to be checked for errors before the message 120A-2 is available to the computation circuit 130. For example, the message 120A-2 can be a second packet of the message that is received or otherwise made available after the message 120A-1. In some implementations, the computation circuit 130 can receive the portions of the messages in a non-contiguous manner. For example, portions of one message can be made available out of order so the message 120A-2 can be made available before the message 120A-1. However, the computation circuit 130 can analyze any of the messages without waiting for all of them to be made available, which can reduce delays.

Message 120A-1 and message 120A-2 may be received over a network, received from another component of a device (e.g., from a host processor of a host computing device that includes the system 100), or received from another source. In some cases, the message 120A-1 may be received by the computation circuit 130 prior to receipt of the message 120A-2 by the computation circuit 130 and/or prior to receipt of the message 120A-2 by the error detection circuit 105 or other components that receive the message 120A-1 and the message 120A-2 from data circuit 110A. In some such cases, there may be circuits (not pictured in FIG. 1) that process and/or store the message 120A-1 and the message 120A-2 as they are received, to perform any suitable buffering or other operations on the message 120A-1 and the message 120A-2 as they are received from the data circuit 110A. In some implementations described herein, the computation circuit 130 may perform operations on the message 120A-1 prior to the message 120A-2 being made available to the computation circuit 130, which may include prior to receipt of the message 120A-2 over the network or from another source, prior to the message 120A-2 being available from such other circuits that process and/or storage messages as they are received, not being accessible in a storage accessible by the computation circuit 130, or otherwise not being available for operations by the computation circuit 130. While the foregoing focused on receipt of the message 120A-1 and the message 120A-2, it should be appreciated that techniques described herein may be used with transmission of messages as well, such as output of the message 120A-1 and the message 120A-2 to the data circuit 110B. In some such cases, the computation circuit 130 may operate on the message 120A-1 prior to the message 120A-2 being available to the computation circuit 130, which may include prior to the message 120A-2 being available for operations by the computation circuit 130, such as by being in a storage accessible to the computation circuit 130, before being generated by a source of the message 120A-2, or otherwise before the message 120A-2 is available.

In some implementations, that portions for a different message are analyzed while portions of other messages are not yet available. As such, when the packets of the message are separated from one another and made available at different times, the computation circuit 130 can separately analyze the portions as they are made available. The analysis of each individual portion can be subsequently combined, as discussed below, to generate an aggregate analysis of the message. For example, portions of different messages can be made available between portions of the same message.

As shown in FIG. 1, in some implementations, the computation circuit 130 can identify the message 120B-1. For example, the message 120B-1 can be a packet of a message different than the packets of message 120A-1 and message 120A-2. The message 120B-1 can be received or made available at after the message 120A-1 and before the message 120A-2. In some implementations, the computation circuit 130 can receive the message 120B-1 between the message 120A-1 and the message 120A-2. For example, the message 120B-1 can be a packet of a second message that is transmitted between first packet of message 120A-1 and the second packet of the message 120A-2. In another example, the message 120A-2 can be made available at a time after the time at which the message 120B-1 is made available.

In some implementations, all the packets of a message are analyzed based on the same error detection configuration, while in other implementations, different packets of the same message can be analyzed based on different error detection configurations. In an implementation in which packets of different messages are made available at interleaving times, the computation circuit 130 can be reconfigured with the error detection configuration as each message is made available for analysis.

In some implementations, the computation circuit 130 can be reconfigured with different error detection configurations during each clock cycle, such that each message can be analyzed by their corresponding error detection configuration. For example, in a case in which there are multiple different messages being analyzed, different messages can correspond to different error detection configurations. In some implementations, the computation circuit 130 can be configured with a first error detection configuration for the message 120A-1, then the computation circuit 130 can be configured with a second error detection configuration for the message 120B-1, and then the computation circuit 130 can be again configured with the first error detection configuration for the message 120A-2.

In some implementations, the computation circuit 130 can analyze the number of bits of the message 120A-2 based on the error detection configuration. For example, the computation circuit 130 can analyze the same number of bits as analyzed in the message 120A-1 if the computation circuit 130 was configured with the same error detection configuration. In some implementations, the second error detection configuration for the message 120B-1 is different from the first error detection configuration for the message 120A-1 and the message 120A-2. In some implementations, the second error detection configuration can specify a number of bits to analyze. The number of bits specified by the second error detection configuration can be different from the number of bits to be analyzed based on the first error detection configuration. For example, computation circuit 130 can analyze a first number of bits (e.g., 32-bits) in the message 120A-1 and the message 120A-2 based on the first error detection configuration, and a different, second number of bits (e.g., 16-bits) in the message 120B-1 based on the second error detection configuration.

In some cases, the message 120A-1 and the message 120A-2 can have a different number of bits. For example, the message 120A-2 might be the last piece of the entire message and thus have fewer bits than message 120A-1. In some implementations, the message 120A-2 can have fewer bits than the number of bits specified for analysis by the error detection configuration. To analyze message having different or few bits, the computation circuit 130 can pre-pad the analyzed portions with zeroes to shift the portions until their bit-length of the portions align with a boundary. For example, the computation circuit 130 can perform pre-padding so that the processing of the portions ends on a 1024-b aligned boundary. By performing the appropriate shifting with the pre-padding of zeros, the computation circuit 130 can extract any number of bits from the messages and then add zeros to extend the extraction to an appropriate bit-length. The computation circuit 130 can then incrementally process and combine error detection values extracted from multiple messages into an aggregate error detection value, as further described in step 506.

As illustrated in FIG. 5, at step 506, one or more of the systems described herein can analyze the message based on analyzing the message 120A-1 and the message 120A-2. For example, the modification circuit 140 can, as part of system 100 in FIG. 1, analyze the message based on analyzing the message 120A-1 and the message 120A-2. The systems described herein can perform step 506 in a variety of ways. In one example, the computation circuit 130 can combine the analysis of the message 120A-1 and the message 120A-2.

In some implementations, the computation circuit 130 can retrieve, from storage, a first error detection value associated with analyzing the message 120A-1. For example, the computation circuit 130 can retrieve the first error detection value from the storage such as a register, random access memory (RAM), or other storage. In some implementations, the computation circuit 130 can retrieve the first error detection value after the message 120A-2 is analyzed and the second error detection value for the message 120A-2 is generated. For example, the computation circuit 130 can retrieve the first error detection value to combine it with the second error detection value to prepare a cumulative analysis of the entire message. In some implementations, the computation circuit 130 can retrieve the first error detection value by using an identifier assigned to the first error detection value. For example, the computation circuit 130 can look up or query the identifier in the storage to identify the first error detection value stored therein.

In some implementations, the computation circuit 130 can generate an aggregate error detection value of the message from the first error detection value and the second error detection value associated with analyzing the second portion of the message. For example, the first error detection value can be a first binary number and the second error detection value can be a second binary number. In some implementations, the computation circuit 130 can generate an aggregate error detection value of the message by combining the first error detection value and the second error detection value. The computation circuit 130 can add the first error detection value and the second error detection value to determine the aggregate error detection value. For example, the computation circuit 130 can perform bitwise operations to combine the error detection values. In some implementations, the computation circuit 130 can determine, based on the aggregate error detection value, whether the message includes the one or more errors. As further described in step 706, the modification circuit can compare the aggregate error detection value to previously generated error detection values.

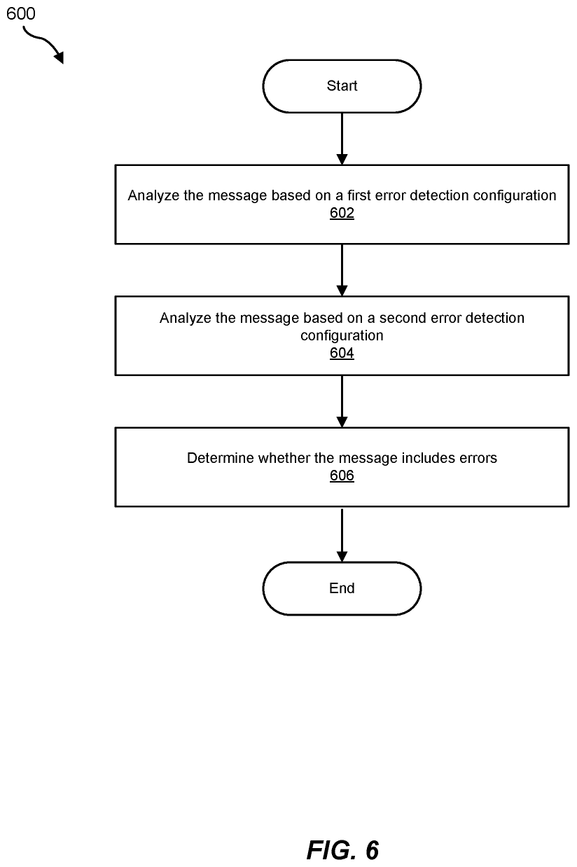

FIG. 6 is a flow diagram of an example computer-implemented method 600 for optimizing the receipt of commands for error detection in a message. The steps shown in FIG. 6 can be performed by any suitable computer-executable code and/or computing system, including system 100 in FIG. 1, system 200 in FIG. 2, system 300 in FIG. 3, and/or variations or combinations of one or more of the same. In one example, each of the steps shown in FIG. 6 can represent an algorithm whose structure includes and/or is represented by multiple sub-steps, examples of which will be provided in greater detail below.

As illustrated in FIG. 6, at step 602, one or more of the systems described herein can analyze the message 120A-1 based on a first error detection configuration. For example, the computation circuit 130 can, as part of system 100 in FIG. 1, analyze the message 120A-1 based on a first error detection configuration. The systems described herein can perform step 602 in a variety of ways. In one example, the division circuit 210 of the computation circuit 130 can analyze the message 120A-1 based on a first error detection configuration for the division circuit 210.

The division circuit 210 can generate the error detection value of the messages based on division techniques. In some implementations, the division circuit 210 can analyze the message to generate the error detection value by generating a polynomial division of bits in the message 120A-1. For example, the division circuit 210 can apply CRC techniques. In some implementations, the error detection configurations for the division circuit 210 can specify the polynomial used for the CRC analysis. Examples of the polynomials include 16-bit, 32-bit, 64-bit, and 128-bit. In some implementations, the division circuit 210 can generate one or more matrices for use in polynomial calculations using matrix multipliers. Such matrix multipliers can, in some such implementations, be circuits arranged for matrix multiplication that form a part of the division circuit 210. Implementations are not limited to operating with any particular arrangement of matrix multipliers. In some implementations, multiple matrix multipliers may be arranged in a pipeline that processes a set of bits for a portion of a message. In one such case, a 1024-bit word of a message is analyzed by a pipeline of multipliers that moves 64-bit portions of the 1024-bit word through the pipeline across iterations, with in one iteration a multiplier processing a 64-bit portion that was processed by the prior multiplier in the prior iteration.

In some implementations that operate with matrices, the division circuit 210 can operate with and/or generate matrices for 16-bit, 32-bit, 64-bit, and/or 128-bit analysis. In some implementations, the division circuit 210 can retrieve the matrices from storage. For example, an error detection configuration may be associated with one or more matrices that are to be used in performing error detection. In such a case, when the division circuit 210 is arranged for error detection in connection with an error detection configuration, a matrix for use in polynomial calculations can be retrieved from a storage and provided to the matrix multiplier(s) for processing. In some implementations, based on the error detection configuration, the division circuit 210 can apply bitwise operations to the bits of the messages and/or the error detection value. For example, the division circuit 210 can reverse the bits of the message before analysis, reverse the bits of the error detection value, or invert the bits of the error detection value.

In some implementations, the division circuit 210 can analyze the message by generating a first error detection value that is a first polynomial division of bits in the message 120A-1 and a second error detection value that is a second polynomial division of bits in the second message 120A-2. For example, the most recent partial CRC result can be the second polynomial division of bits forwarded by the division circuit 210 to be combined with a previously calculated partial CRC result that is the second polynomial division of bits. In some cases, the message 120A-1 and the message 120A-2 can have a different number of bits. For example, the message 120A-2 might be the last piece of the entire message and thus have fewer bits than message 120A-1. In some implementations, the message 120A-2 can have fewer bits than the number of bits specified for analysis by the error detection configuration. To analyze messages having different bit-lengths, the division circuit 210 can pre-pad the messages with zeroes to shift the portions until their bit-length of the messages align with a boundary. For example, the division circuit 210 can perform pre-padding so that the processing of the bits of the messages ends on a 1024-b aligned boundary. By performing the appropriate shifting with the pre-padding of zeros, the division circuit 210 can extract any sized region from the message and then add zeros to extend the extracted region to an appropriate bit-length.

The division circuit 210 can incrementally process and combine multiple error detection values (e.g., CRC results based on the polynomial division) into an aggregate error detection value. In some implementations, the division circuit 210 generates the aggregate error detection value based on a combination of the currently generated error detection value and a previously generated error detection value. In some implementations, the division circuit 210 updates the aggregate error detection value based on a combination of the previously generated aggregate error detection value and a newly generated error detection value. In some implementations, the division circuit 210 can separately handle the previously generated aggregate error detection value and the newly generated error detection value. For example, the division circuit 210 can separately handle data advancement and state advancement.

In some implementations, the division circuit 210 can generate a bit advance matrix to advance the state by a certain number of bits. For example, the state can be advanced by multiplying it by the bit advance matrix, which can be Mn, where M is the width of the data and n is the number of bits to be advanced. For the data advancement of the newly generated aggregate error detection value, the division circuit 210 can use matrix multipliers. For example, if the newly generated error detection value is 1024 bits, the division circuit 210 can retrieve (e.g., from storage) a 64 by 64 matrix and multiply it on each 64 bits of that newly generated error detection value to advance by 64 bits every clock cycle. For the state advancement of the previously generated aggregate error detection value, the division circuit 210 can use matrix multipliers. For example, if the previously generated error detection value is 1024 bits, the division circuit 210 can retrieve (e.g., from storage) a matrix and multiply the entire matrix to advance the previously generated error detection value by 1024-bits in a single cycle.

As illustrated in FIG. 6, at step 604, one or more of the systems described herein can analyze the message 120A-1 based on a second error detection configuration. For example, the computation circuit 130 can, as part of system 100 in FIG. 1, analyze the message 120A-1 based on a second error detection configuration. The systems described herein can perform step 604 in a variety of ways. In one example, the addition circuit 220 of the computation circuit 130 can analyze the message 120A-1 based on a second error detection configuration for the addition circuit 220. In some implementations, the addition circuit 220 can analyze the message by generating a first addition of bits in the message 120A-1 and a second addition division of the second message 120A-2. For example, each of the checksum results can be analyzed by the modification circuit 140 to determine whether each of the messages include errors.

The addition circuit 220 can generate the error detection value of the messages based on addition techniques. For example, the addition circuit 220 can apply checksum techniques. In some implementations, the error detection configurations for the addition circuit 220 can specify which type of checksum protocol (TCP/UDP) to utilize, whether to generate a 16-bit checksum or a status indicator, the size and offset of the portion for checksum processing, the offset of the checksum field in the portion, and any additional data to factor into the checksum calculation. In some implementations in which the specified portions of the packets of the messages are analyzed in a manner in accordance with the error detection configuration, the number of bits that need to be analyzed can be less than what was needed with prior solutions that analyzed the entire message, resulting in reduction of resources needed to analyze the messages for error detection as compared to prior solutions.

As illustrated in FIG. 6, at step 606, one or more of the systems described herein can determine whether the message includes one or more errors. For example, the modification circuit 140 can, as part of system 100 in FIG. 1, determine whether the message includes one or more errors based on the error detection values derived from the first error detection configuration and the second error detection configuration. The systems described herein can perform step 606 in a variety of ways. In one example, the modification circuit 140 can determine whether the message includes errors based on a plurality of error detection values derived from a plurality of error detection configurations. For example, the modification circuit 140 can detect the errors based on the CRC analysis and the checksum analysis. While independent analysis by CRC fails to detect errors that alter the data by the polynomial used in the division and independent analysis by checksum fails to detect double errors that do not change the sum of the bits, analysis based on both error detection configuration improves the ability to detect the errors in the message.

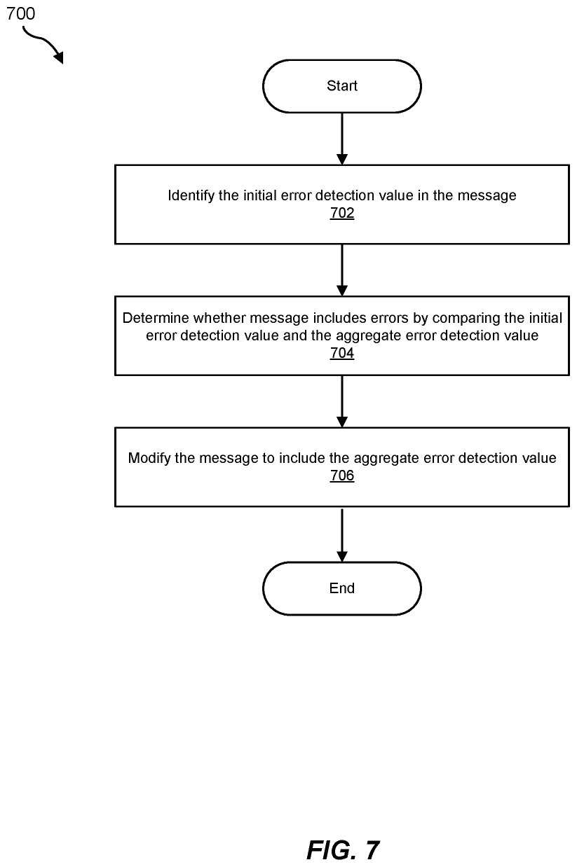

FIG. 7 is a flow diagram of an example computer-implemented method 700 for optimizing the receipt of commands for error detection in a message. The steps shown in FIG. 7 can be performed by any suitable computer-executable code and/or computing system, including system 100 in FIG. 1, system 200 in FIG. 2, system 300 in FIG. 3, and/or variations or combinations of one or more of the same. In one example, each of the steps shown in FIG. 7 can represent an algorithm whose structure includes and/or is represented by multiple sub-steps, examples of which will be provided in greater detail below.

As illustrated in FIG. 7, at step 702, one or more of the systems described herein can identify the initial error detection value in the message. For example, the modification circuit 140 can, as part of system 100 in FIG. 1, identify the initial error detection value in the message 120A-1. The systems described herein can perform step 702 in a variety of ways. In one example, the computation circuit 130 can identify an initial error detection value that was generated and edited into the message (e.g., by another circuit). In some implementations, the modification circuit 140 can copy 1, 2, 4, 8, or 16 bytes of data, which can be the initial error detection value, from the message. In another example, the modification circuit 140 can receive the error detection value from the computation circuit 130. In yet another example, the modification circuit 140 can receive the error detection value from other circuits (e.g., a different error detection circuit). In some implementations, the modification circuit 140 can copy 1, 2, 4, 8, or 16 bytes of data, which can be the initial error detection value, that is received from the computation circuit 130 or the other circuits.

As illustrated in FIG. 7, at step 704, one or more of the systems described herein can determine whether the message includes one or more errors by comparing the initial error detection value and the aggregate error detection value. For example, the modification circuit 140 can, as part of system 100 in FIG. 1, determine whether the message includes one or more errors by comparing the initial error detection value and the aggregate error detection value. The systems described herein can perform step 704 in a variety of ways. In one example, the modification circuit 140 can perform modification operations on the messages after they were analyzed by the computation circuit 130.

For example, the modification circuit 140 can compare 1, 2, 4, 8, or 16 bytes of data associated with the error detection value. In some implementations, the messages can include a previously generated error detection value (e.g., CRC or checksum value). Based on the comparison, the modification circuit 140 can detect whether the message associated with the error detection value has errors. If the comparison indicates that the error detection value and the previously generated result in the message are the same, then the message does not have any errors. Conversely, if the comparison indicates that the error detection value and the previously generated result in the message are different, then the message includes errors. In some implementations, the modification circuit 140 can store the comparison. For example, the modification circuit 140 can store the comparison in a storage or buffer. In some implementations, the modification circuit 140 can transmit the comparison. For example, the modification circuit 140 can transmit the comparison to other circuits via a status bus or a sideband output channel.

As illustrated in FIG. 7, at step 706, one or more of the systems described herein can modify the message to include the aggregate error detection value. For example, the modification circuit 140 can, as part of system 100 in FIG. 1, modify the message (e.g., the message 120A-1, the message 120A-2, or the message 120B-1) to include the aggregate error detection value. The systems described herein can perform step 706 in a variety of ways. In one example, the modification circuit 140 can insert and/or edit the aggregate error detection value into the message 120A-1 or the message 120A-2. In one example, the modification circuit 140 can insert and/or edit the aggregate error detection value into the payload of a message. In another example, the modification circuit 140 can modify the message to include the error detection value (e.g., computed CRC or checksum). In yet another example, the modification circuit 140 can insert and/or edit 1, 2, 4, 8, or 16 bytes of data, which can be the aggregate error detection value, into the message.

In some implementations, the modification circuit 140 can copy, edit, and/or insert the aggregate error detection value into the message. For example, in a cut through edit approach, the modification circuit 140 can identify that the message is available to receive the aggregate error detection value. In some implementations, the modification circuit 140 can detect that the message is available by detecting a status indicator in the message. For example, the status indicator can indicate that message is available to receive the aggregate error detection value. In some implementations, the modification circuit 140 can detect that the message is available in responsive to receiving an indicator from another circuit. For example, the modification circuit 140 can receive, from the computation circuit 130, an indicator that the message is available to be written. The modification circuit 140 can in response to that identification insert the aggregate error detection value in the message that is available. In some implementations, the modification circuit 140 can insert the aggregate error detection value in the message in a particular region or location within the message. For example, the modification circuit 140 can generate a copy operation to insert the aggregate error detection value after a particular offset (e.g., number of bits) into the message.

In some implementations, the modification circuit 140 can buffer and/or store the aggregate error detection value prior to copying, editing, or insertion of the aggregate error detection value into the message. For example, in a store and forward edit approach, the modification circuit 140 can identify that the message is not available to receive the aggregate error detection value. For example, the modification circuit 140 can determine that a portion of the message that is configured to receive the message is not yet available. The portion of the message that is configured to receive the message may include the header or region that holds the aggregate error detection value. For example, the modification circuit 140 can determine that the portion of the message that is configured to receive the message cannot be overwritten or copied until a particular time or a particular condition is met. The modification circuit 140 can utilize a buffer, storage, or any other memory to temporarily store the aggregate error detection value. For example, the buffer can store 1, 2, 4, 8, or 16 bytes of data, which can be a size of the aggregate error detection value.

The modification circuit 140 can identify when the portion of the message configured to receive the aggregate error detection value is available. In some implementations, the modification circuit 140 can retrieve the aggregate error detection value from the buffer when the portion of the message is available. After retrieving the aggregate error detection value, the modification circuit 140 can copy, edit, and/or insert the aggregate error detection value in the message. In some implementations, the modification circuit 140 can insert the aggregate error detection value in a particular region or location within the message. For example, the modification circuit 140 can generate a copy operation to insert the aggregate error detection value after a particular offset (e.g., number of bits) into the message.

As the messages are transmitted to other circuits (e.g., inline circuits), the error detection value in those messages can be used by those other circuits (e.g., other modification circuits) as a reference against which to compare error detection value that they generate. The other circuits can generate error detection values based on of the messages that they receive, and the modification operation can compare the generated error detection value to the previously generated error detection value that is already in the message, as similarly described in step 702 and step 704.

While an example was described in connection with FIG. 7 of editing a message to include an error detection value, implementations are not so limited to editing a message to add an error detection value to a message. Implementations that include a modification circuit can operate with any suitable value(s) or data to add or otherwise modify a message based on the value(s)/data.

While the foregoing disclosure sets forth various implementations using specific block diagrams, flowcharts, and examples, each block diagram component, flowchart step, operation, and/or component described and/or illustrated herein can be implemented, individually and/or collectively, using a wide range of hardware, software, or firmware (or any combination thereof) configurations. In addition, any disclosure of components contained within other components should be considered example in nature since many other architectures can be implemented to achieve the same functionality.

In some examples, all or a portion of system 100 in FIG. 1 can represent portions of a cloud-computing or network-based environment. Cloud-computing environments can provide various services and applications via the Internet. These cloud-based services (e.g., software as a service, platform as a service, infrastructure as a service, etc.) can be accessible through a web browser or other remote interface. Various functions described herein can be provided through a remote desktop environment or any other cloud-based computing environment.

In various implementations, all or a portion of system 100 in FIG. 1 can facilitate multi-tenancy within a cloud-based computing environment. In other words, the modules described herein can configure a computing system (e.g., a server) to facilitate multi-tenancy for one or more of the functions described herein. For example, one or more of the modules described herein can program a server to enable two or more clients (e.g., customers) to share an application that is running on the server. A server programmed in this manner can share an application, operating system, processing system, and/or storage system among multiple customers (i.e., tenants). One or more of the modules described herein can also partition data and/or configuration information of a multi-tenant application for each customer such that one customer cannot access data and/or configuration information of another customer.

According to various implementations, all or a portion of system 100 in FIG. 1 can be implemented within a virtual environment. For example, the modules and/or data described herein can reside and/or execute within a virtual machine. As used herein, the term “virtual machine” generally refers to any operating system environment that is abstracted from computing hardware by a virtual machine manager (e.g., a hypervisor).

In some examples, all or a portion of system 100 in FIG. 1 can represent portions of a mobile computing environment. Mobile computing environments can be implemented by a wide range of mobile computing devices, including mobile phones, tablet computers, e-book readers, personal digital assistants, wearable computing devices (e.g., computing devices with a head-mounted display, smartwatches, etc.), variations or combinations of one or more of the same, or any other suitable mobile computing devices. In some examples, mobile computing environments can have one or more distinct features, including, for example, reliance on battery power, presenting only one foreground application at any given time, remote management features, touchscreen features, location and movement data (e.g., provided by Global Positioning Systems, gyroscopes, accelerometers, etc.), restricted platforms that restrict modifications to system-level configurations and/or that limit the ability of third-party software to inspect the behavior of other applications, controls to restrict the installation of applications (e.g., to only originate from approved application stores), etc. Various functions described herein can be provided for a mobile computing environment and/or can interact with a mobile computing environment.

The process parameters and sequence of steps described and/or illustrated herein are given by way of example only and can be varied as desired. For example, while the steps illustrated and/or described herein can be shown or discussed in a particular order, these steps do not necessarily need to be performed in the order illustrated or discussed. The various example methods described and/or illustrated herein can also omit one or more of the steps described or illustrated herein or include additional steps in addition to those disclosed.

While various implementations have been described and/or illustrated herein in the context of fully functional computing systems, one or more of these example implementations can be distributed as a program product in a variety of forms, regardless of the particular type of computer-readable media used to actually carry out the distribution. The implementations disclosed herein can also be implemented using modules that perform certain tasks. These modules can include script, batch, or other executable files that can be stored on a computer-readable storage medium or in a computing system. In some implementations, these modules can configure a computing system to perform one or more of the example implementations disclosed herein.

The preceding description has been provided to enable others skilled in the art to best utilize various implementations of the examples disclosed herein. This example description is not intended to be exhaustive or to be limited to any precise form disclosed. Many modifications and variations are possible without departing from the spirit and scope of the present disclosure. The implementations disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A method for error detection in a message, the method being performed with at least one circuit, the method comprising:
identifying, based on an error detection configuration of the at least one circuit, a first portion of the message to be checked for errors before a second portion of the message is available to the at least one circuit, the first portion being less than all of the message to be checked for one or more errors;
analyzing a number of bits of the first portion of the message using the at least one circuit and based on the error detection configuration; and
based on analyzing the first portion, determining whether the message includes the one or more errors.

2. The method of claim 1, further comprising:
configuring the at least one circuit with the error detection configuration from a plurality of error detection configurations, prior to identifying the first portion of the message to be checked for the one or more errors.

3. The method of claim 1, wherein the number of bits is a first number of bits, and further comprising:
receiving, based on the error detection configuration of the at least one circuit, the second portion of the message to be checked for the one or more errors, the second portion being less than all of the message to be checked for the one or more errors;
analyzing a second number of bits of the second portion of the message using the at least one circuit and based on the error detection configuration; and
determining, based on analyzing of the first portion and the second portion, whether the message includes the one or more errors.

4. The method of claim 3, further comprising:
retrieving, from memory, a first error detection value associated with analyzing the first portion of the message;
generating an aggregate error detection value of the message from the first error detection value and a second error detection value associated with analyzing the second portion of the message; and
determining, based on the aggregate error detection value, whether the message includes the one or more errors.

5. The method of claim 4, further comprising:
identifying, using the at least one circuit, an initial error detection value that was generated and edited into the message; and
determining whether the message includes the one or more errors by comparing the aggregate error detection value to the initial error detection value in the message.

6. The method of claim 4, further comprising:
modifying the message to include the aggregate error detection value.

7. The method of claim 1, wherein:
the error detection configuration is a first error detection configuration;
the number of bits is a first number of bits; and
the method further comprises:
configuring the at least one circuit with a second error detection configuration of a plurality of error detection configurations, the plurality of error detection configurations comprising the first error detection configuration and the second error detection configuration being different from the first error detection configuration;
identifying, based on the second error detection configuration of the at least one circuit, a third portion and a fourth portion of the message to be checked for the one or more errors, the third portion and the fourth portion being less than all of the message to be checked for the one or more errors;
analyzing a second number of bits of the third portion and the fourth portion of the message using the at least one circuit and based on the second error detection configuration; and
based on analyzing the third portion and the fourth portion, determining whether the message includes the one or more errors.

8. The method of claim 7, further comprising:
analyzing, using the at least one circuit and based on the first error detection configuration, the first portion and the second portion of the message by generating a first polynomial division of bits in the first portion and a second polynomial division of the second portion of the message;
analyzing, using the at least one circuit and based on the second error detection configuration, the third portion and the fourth portion of the message by generating a first addition of bits in the third portion and a second addition of the fourth portion of the message; and
determining whether the message includes the one or more errors based on analyzing the first portion, the second portion, the third portion, and the fourth portion.

9. The method of claim 1, wherein:
the error detection configuration is a first error detection configuration;
the message is a first message;
the number of bits is a first number of bits; and
the method further comprises:
configuring the at least one circuit with a second error detection configuration of a plurality of error detection configurations, the plurality of error detection configurations comprising the first error detection configuration and the second error detection configuration being different from the first error detection configuration;
identifying, based on the second error detection configuration of the at least one circuit, a third portion of a second message to be checked for the one or more errors, the third portion being less than all of the second message to be checked for the one or more errors;
analyzing a second number of bits of the third portion of the second message using the at least one circuit and based on the second error detection configuration; and
based on analyzing the third portion, determining whether the second message includes the one or more errors.

10. The method of claim 9, wherein:
the at least one circuit receives the third portion of the second message between the first portion of the first message and the second portion of the first message;
configuring of the at least one circuit with the second error detection configuration is performed after analyzing the first portion of the message using the at least one circuit and based on the first error detection configuration; and
the method further comprises:
configuring the at least one circuit with the first error detection configuration after analyzing the third portion of the second message using the at least one circuit and based on the second error detection configuration.

11. A system for error detection in a message, the system comprising:
a computation circuit configured to:
identify, based on an error detection configuration of the computation circuit, a first portion of the message to be checked for one or more errors before a second portion of the message is available to the computation circuit, the first portion being less than all of the message to be checked for the one or more errors; and
analyze a number of bits of the first portion of the message based on the error detection configuration; and
a modification circuit configured to, based on analyzing the first portion, determine whether the message includes the one or more errors.

12. The system of claim 11, wherein the computation circuit is further configured with the error detection configuration from a plurality of error detection configurations, prior to identifying the first portion of the message to be checked for the one or more errors.

13. The system of claim 11, wherein:
the computation circuit is further configured to:
receive, based on the error detection configuration of the computation circuit, the second portion of the message to be checked for the one or more errors, the second portion being less than all of the message to be checked for the one or more errors; and
analyze the number of bits of the second portion of the message based on the error detection configuration; and
the modification circuit is further configured to:
determine, based on analyzing of the first portion and the second portion, whether the message includes the one or more errors.

14. The system of claim 13, wherein:
the computation circuit is further configured to:
retrieve, from memory, a first error detection value associated with analyzing the first portion of the message; and
generate an aggregate error detection value of the message from the first error detection value and a second error detection value associated with analyzing the second portion of the message; and
the modification circuit is further configured to:
determine, based on the aggregate error detection value, whether the message includes the one or more errors.

15. The system of claim 14, wherein the modification circuit is further configured to:
identify an initial error detection value that was generated and edited into the message; and
determine whether the message includes the one or more errors by comparing the aggregate error detection value to the initial error detection value in the message.

16. The system of claim 11, wherein:
the error detection configuration is a first error detection configuration;
the number of bits is a first number of bits;
the computation circuit is further configured with a second error detection configuration of a plurality of error detection configurations, the plurality of error detection configurations comprising the first error detection configuration and the second error detection configuration being different from the first error detection configuration;
the computation circuit is further configured to:
identify, based on the second error detection configuration of the computation circuit, a third portion and a fourth portion of the message to be checked for the one or more errors, the third portion being less than all of the message to be checked for the one or more errors; and
analyze a second number of bits of the third portion and the fourth portion of the message based on the second error detection configuration; and
the modification circuit is further configured to, based on analyzing the third portion and the fourth portion, determine whether the message includes the one or more errors.

17. The system of claim 16, wherein:
the computation circuit further comprises a division circuit and an addition circuit;
the division circuit is configured to analyze, based on the first error detection configuration, the first portion and the second portion of the message by generating a first polynomial division of bits in the first portion and a second polynomial division of the second portion of the message;
the addition circuit is configured to analyze, based on the second error detection configuration, the third portion and the fourth portion of the message by generating a first addition of bits in the third portion and a second addition of the fourth portion of the message; and
the modification circuit is further configured to determine whether the message includes the one or more errors based on analyzing the first portion, the second portion, the third portion, and the fourth portion.

18. The system of claim 11, wherein:
the error detection configuration is a first error detection configuration;
the message is a first message;
the number of bits is a first number of bits;
the computation circuit is further configured with a second error detection configuration of a plurality of error detection configurations, the plurality of error detection configurations comprising the first error detection configuration and the second error detection configuration being different from the first error detection configuration;
the computation circuit is further configured to:
identify, based on the second error detection configuration of the computation circuit, a third portion of a second message to be checked for the one or more errors, the third portion being less than all of the second message to be checked for the one or more errors; and
analyze a second number of bits of the third portion of the second message based on the second error detection configuration; and
the modification circuit is further configured to, based on analyzing the third portion, determine whether the second message includes the one or more errors.

19. The system of claim 18, wherein:
the computation circuit receives the third portion of the second message between the first portion of the first message and the second portion of the first message;
configuring of the computation circuit with the second error detection configuration is performed after analyzing the first portion of the message based on the first error detection configuration; and
the computation circuit is further configured with the first error detection configuration after analyzing the third portion of the second message based on the second error detection configuration.

20. At least one computer-readable storage medium having encoded thereon executable instructions that, when executed by at least one circuit, cause the at least one circuit to perform a method comprising:
identifying, based on an error detection configuration of the at least one circuit, a first portion of a message to be checked for errors before a second portion of the message is available to the at least one circuit, the first portion being less than all of the message to be checked for one or more errors;
analyzing a number of bits of the first portion of the message using the at least one circuit and based on the error detection configuration; and
based on analyzing the first portion, determining whether the message includes the one or more errors.
